(19) United States
(12) Patent Application Publication
(10) Pub. No.: US 2015/0130610 A1
(43) Pub. Date: May 14, 2015

(54) FIRE ALARM POWER LINE CARRIER COM-SYSTEM

(71) Applicant: Christopher George KALIVAS, (US)

(72) Inventors: Christopher George KALIVAS, Patchogue, NY (US); Steven Perry Apelman, Centereach, NY (US)

(73) Assignee: Christopher George KALIVAS, Patchogue, NY (US)

(21) Appl. No.: 14/497,322

(22) Filed: Sep. 26, 2014

Related U.S. Application Data
(63) Continuation-in-part of application No. 13/320,497, filed on Nov. 14, 2011, now Pat. No. 8,878,665.
Application No. 13/320,497 is a continuation-in-part of application No. PCT/US2011/036233, filed on May 14, 2010.
(60) Provisional application No. 61/345,056, filed on May 14, 2010.

(51) Int. Cl. G08B 25/06; G08B 17/00

(52) U.S. Cl. CPC G08B 25/06; G08B 17/00
USPC 340/538

(57) ABSTRACT

A fire alarm system includes a transceiver. The transceiver has: a housing; conductors for receiving power from power lines; power output conductors for transmitting the power to a local alarm; and a connector for the alarm conductor of the local alarm. The transceiver has a trigger circuit, responsive to an alarm condition. A transmitter circuit responds to the alarm condition by injecting a signal onto a power conductor, using power line carrier technology. A receiver circuit responds to a second signal, similar to the first signal, by triggering the transmitter circuit; and by triggering the local alarm.

### PRIORITY

This application Continuation-In-Part of and takes priority and benefit from Ser. No. 13/320,497 filed Nov. 14, 2011 and all its parent applications, for any common subject matter, and is a continuation in part thereof for any new matter.

Ser. No. 13/320,497 is currently pending and allowed a Bypass Continuation-In-Part of, and takes priority and benefit under 35 USC111(a) from PCT Application: PCTUS2011/036233, filed May 12, 2011, pending, for any common subject matter, and is a continuation in part thereof for any new matter.

Said PCT application is a non-provisional bypass application, of and takes priority from U.S. Provisional Application: 61345,056, filed May 14, 2010, pending when the PCT Application was filed. The present application also takes priority, for any common subject matter.

The present application also takes priority, for any common subject matter, from said U.S. Provisional Application: 61345056, filed May 14, 2010, through said PCT Application.

Those Applications are all hereby incorporated by reference.

### FIELD

The present invention is a device, and a two-wire interconnection scheme, that serves as an adapter 4 to interconnect and activate numerous residential 120 VAC operated smoke alarms 5 without the addition of a third red electrical conductor wire 6 required to trigger the independent audio alert line at the local alarm drive A. The present invention includes methods of installing and operating such a device.

### BACKGROUND OF THE INVENTION

Fire Codes for buildings in most States require that one and two story dwellings maintain and often upgrade the alarm systems by interconnecting their smoke alarms and CO detectors for simultaneous operation. After interconnection, when one alarm sensor detects a hazard at one end of the house, all other installed alarm sensors, even ones located at the other end of a house, as well as each bedroom, are energized simultaneously and begin to emit their alarm sound. (FIG. 3)

Alarm interconnection has been proven to give people more time to escape from a structural fire. That extra time results in the saving of lives and property in a far greater proportion than when interconnection is not used.

The conventional method of accomplishing the necessary interconnection is to install each device with a third electrical wire connection 6. Two wires, white 6W and black 6B, provide the commercial power, such as 120 VAC 60 Hz power in the United States, or other commercial power, such as 230 VAC 50 Hz found in other countries.

A third trigger wire, usually red, is normally strung between alarms and is employed for interconnecting the low voltage signal needed to activate the other alarms installed within the building. This is typically a standard 9 VDC. Most United States Building and Fire Codes require this form of alarm interconnection in all new construction. Property Maintenance Codes require existing homes to be upgraded in this manner when and where it is feasible. When a fire or CO alarm actuates, it shorts this 9 VDC to its yellow alarm wire, which is conductively connected to the structure's red alarm wire system.

### THE PRESENT INVENTION

This present invention makes it possible for all existing homes to receive the enhanced safety benefit of interconnecting all alarms in a house, while eliminating the expensive burden and inconvenience of rewiring, while still complying with state and local codes regarding alarm systems.

### BRIEF DESCRIPTION OF THE DRAWINGS

FIG. 1 is a circuit diagram of the present invention.

FIG. 2 is a perspective view of the present invention.

FIG. 3 is a block diagram showing use of three units of the invention in a dwelling.

FIG. 4 is a circuit diagram of the present invention, similar to FIG. 1, with a modified power supply.

FIG. 5 is a block diagram of the elements of the transceiver 4.

FIG. 6 is a perspective view of an alternate embodiment.

FIG. 7 is a perspective view of another alternate embodiment.

FIG. 8 is a perspective view of another alternate embodiment.

### DETAILED DESCRIPTION

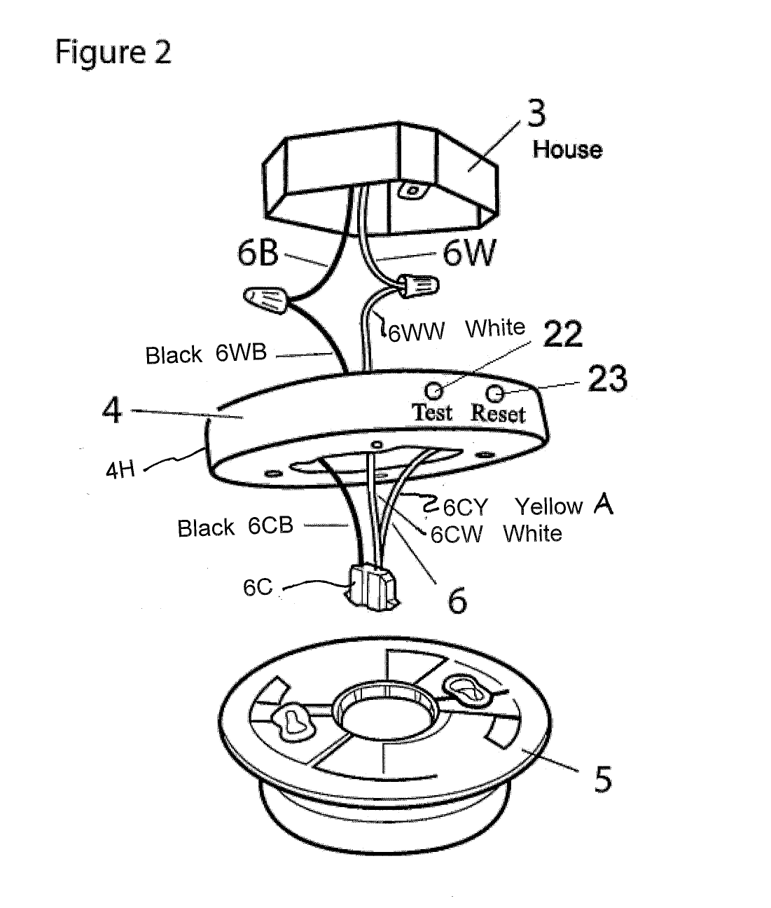

FIG. 2 shows that this present invention is a interface 4 also called in this application a transceiver 4, which simply mounts between:
an electrical receptacle 3 that supplies the structure's 120 VAC commercial power, and
a local smoke alarm or CO detector 5 as in FIG. 2.

Other commercial power voltages will be preferred in various other countries.

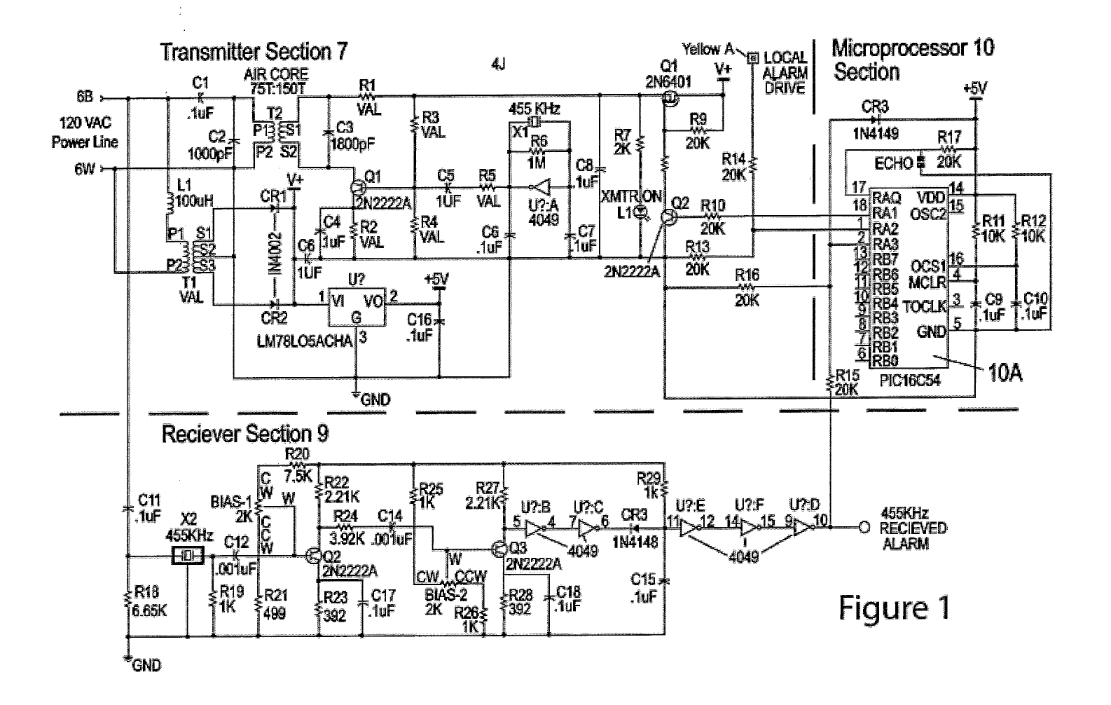

The interface 4 comprises a 2-wire interconnected transceiver circuit, generally designated 4J, (FIG. 1) that uses power line carrier technology to inject an RF signal onto the two conductors: Black 6B and White 6W (FIG. 2), that deliver the commercial power.

Three wires feed from the alarm to the transceiver, which is part of the interface unit, whose exterior housing is shown as 4H in FIG. 2. From standardized connector 6C leads: a black AC power line 6CB; a white AC power line 6CW; ands a Yellow line 6CY, also shown in FIG. 1 as Yellow A, at the local alarm drive. The transceiver 4J (FIG. 1) comprises both a transmitter circuit 7 and a receiver circuit 9. The standard connectors 6C vary by smoke detector brand.

The transmitter portion 7 of the present invention is equipped with a trigger circuit 10 used to monitor the activity of output line Yellow A, usually a yellow wire Yellow A, of the local fire alarm sensor 5 it is attached to. When a low voltage (9 VDC) output signal is received on wire Yellow A (FIG. 1), from the red wire (FIG. 2) of a local fire alarm 5, the Radio Frequency (RF) transmitter 7 is activated, resulting in a Radio Frequency signal, preferably in this embodiment a sine wave of of 455 KHz, being injected via wires 6B & 6W onto the 2 wire 120 VAC power lines 6W & 6B within the building for the purpose of activating any other fire alarm system transceiver 4 (FIGS. 2 & 3) attached to the same 120 VAC power lines anywhere within the same structure, and thereby sounding the local fire alarm 5.

Should the 455 KHz receiver portion 9 (FIG. 1) of the present invention detect the presence of a 455 KHz signal injected into the power lines 6W & 6B from any other fire alarm sensor 5 on the 120 VAC power line, it processes that signal through a state-of-the-art microprocessor 10A (FIG. 1) using specialized software for determining the validity of the alarm status. Such software can, for example, check the duration and or frequency of the alarm signal to make sure it's not a transient signal. When the validity of the alarm condition is confirmed, the microprocessor 10A (FIG. 1) activates the local fire alarm unit 5 (FIG. 2) attached to the present invention, and begins to emit the alarm sound through wire at Yellow A (FIG. 1) shown also as 6CY in FIG. 2.

This system allows as many alarms to be interconnected as desired. A smoke alarm and a carbon monoxide alarm could be in each room of as many rooms or zones as there are rooms or zones supplied by the commercial power circuit. If each alarm 5 were connected through an interface transceiver such as 4, all would be interconnected. All would alarm in response to an alarm from any one smoke, fire, or CO alarm.

A further feature of the present invention is to execute an “echo” transmission of the 455 KHz. signal, when a confirmed alert is detected from another alarm 5, so that it also acts as a 455 KHz. generator for the purpose of activating all other fire alarm units 5 attached to the building's 120 VAC power lines. This feature makes each transceiver 4 a repeater, and thereby increases the range of each alarm to every other alarm on the house circuit.

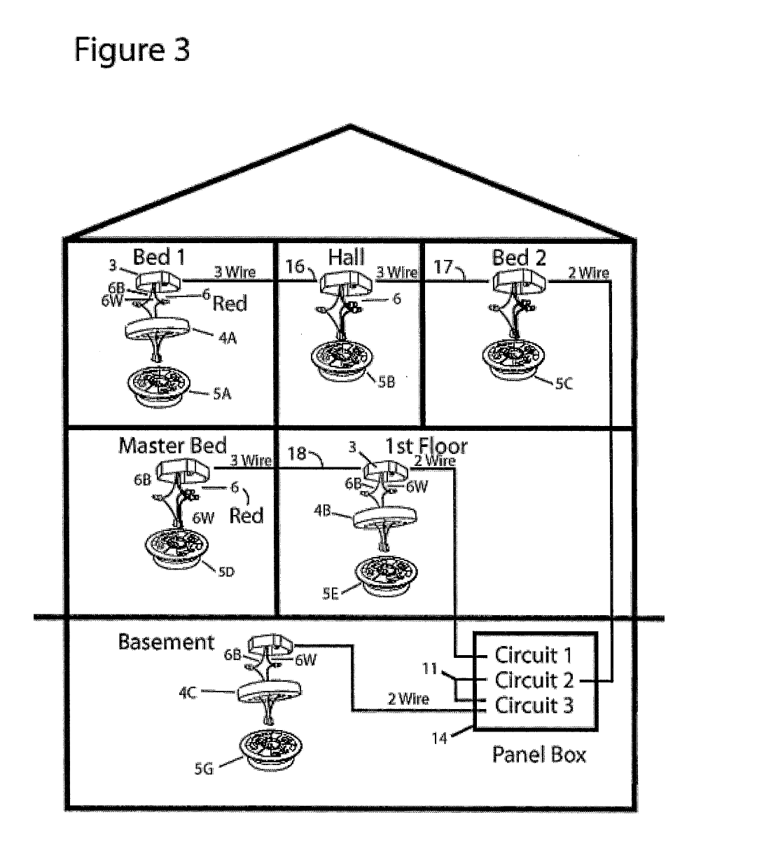

As in FIG. 3, when there is a section of a house, such as:
Bed 1, Hall and Bed 2,

that is already interconnected by a third conductor 6 Red, which is one of the three-wire conductors 16-17 therebetween, and

additional smoke alarms such as 5D, 5E and 5G need to be interconnected to them, (FIG. 3) then,

only one adapter, such as 4A, is needed to connect all the transceiver 4 equipped local alarms 5 such as 5A, 5E & 5G to the group (5G, 5B and 5C) that is pre-wired by three-wire conductors 16-17.

Similarly, transceiver 4B connects the three-wired conductor 18 group of:
1st Floor alarm 5D and Master Bed alarm 5E,

to all the other in-house alarms 5A-5C & 5G.

Any further additional transceiver mounted alarms would also be thereby connected to the pre-existing interconnected alarm group through the group's transceiver 4B.

If:
two devices, such as 4A & 4B are used in a house; and
they are not on the same phase, (e.g. Circuit 2 & Circuit 3) of the electrical supply; then a bridge circuit 11 must be installed between the two phases (Circuit 2 & Circuit 3) in the panel box 14.

Or, the installer can change the position of that particular circuit onto the same phase as the others, as by moving the 2 Wire from Circuit 3 to Circuit 2. He can usually do so at the circuit breaker panel box 14.

Thus, as many alarms can be interconnected in a structure, as there are existing commercial power supply points, without hiring a licensed electrician to run a new three-wire alarm circuit for each new local alarm 5.

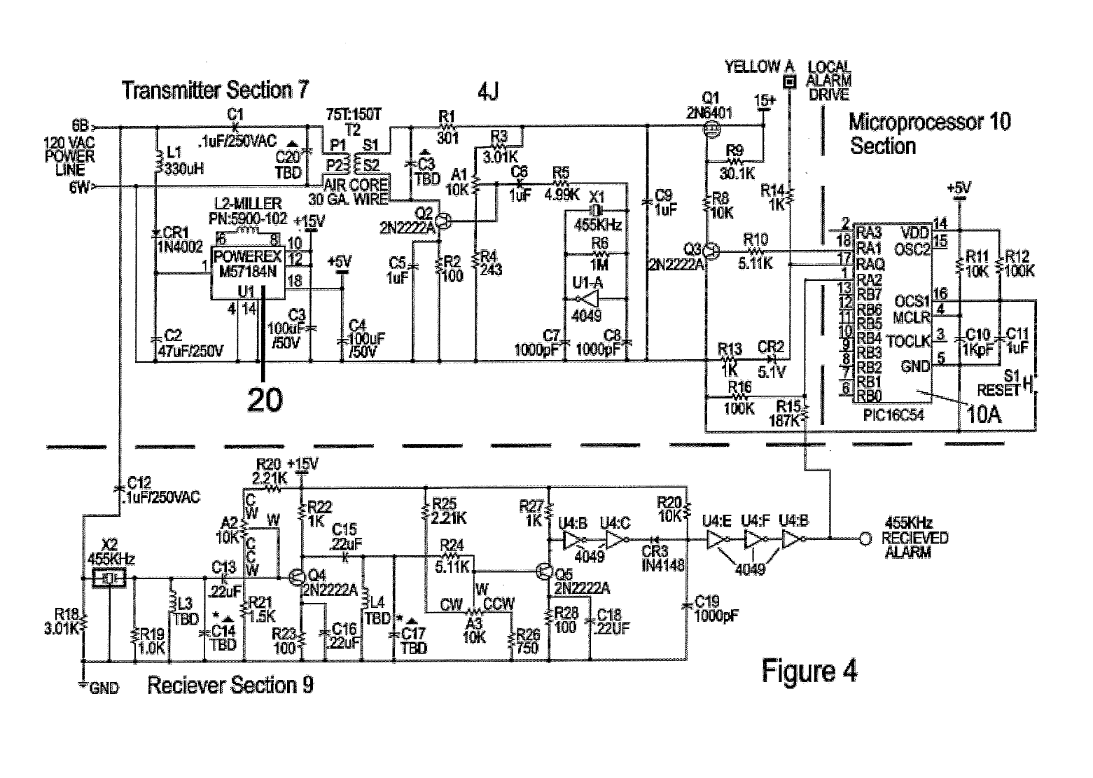

FIG. 4 is a circuit diagram, similar to FIG. 1. FIG. 4 shows another embodiment with a slightly different power supply 20, which is preferably a Powerex M57184N, in transmitter section 7.

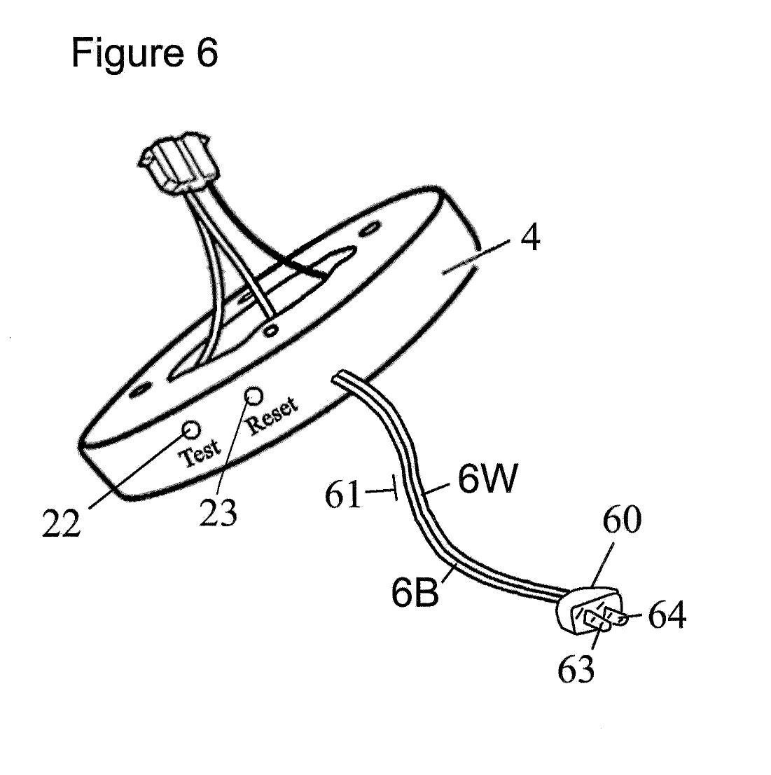

To further simplify installation, transceiver 4 can be equipped with an AC plug 60 FIG. 6, to plug directly into AC receptacles, where fire codes don't forbid such installations. This plug obviates the need to open boxes and twist wires. A disadvantage of a plug 60 is that, it may be easily unplugged, which would disable the alarm.

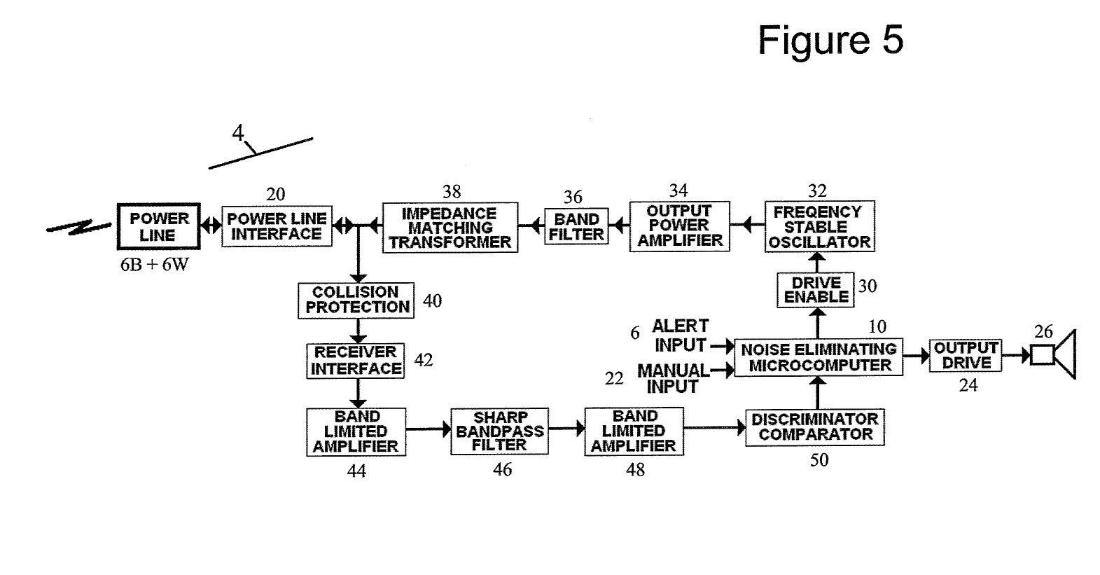

FIG. 5 is a block diagram of the elements of the transceiver 4. Power is supplied through 110 Volt power wires 6B and 6W.

This power goes through a power line interface 20, which provides low voltage DC power to the transceiver 4.

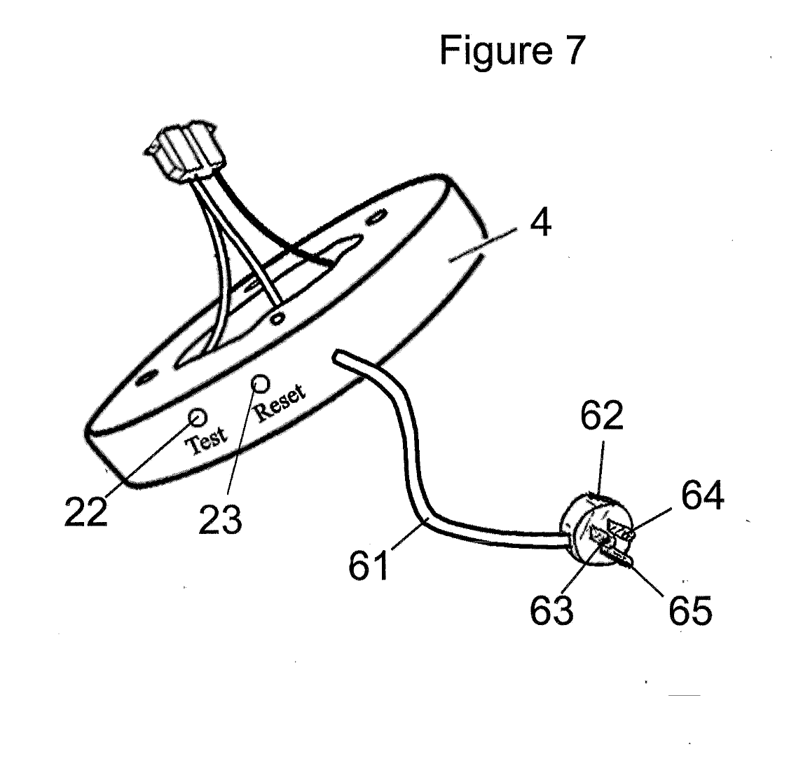

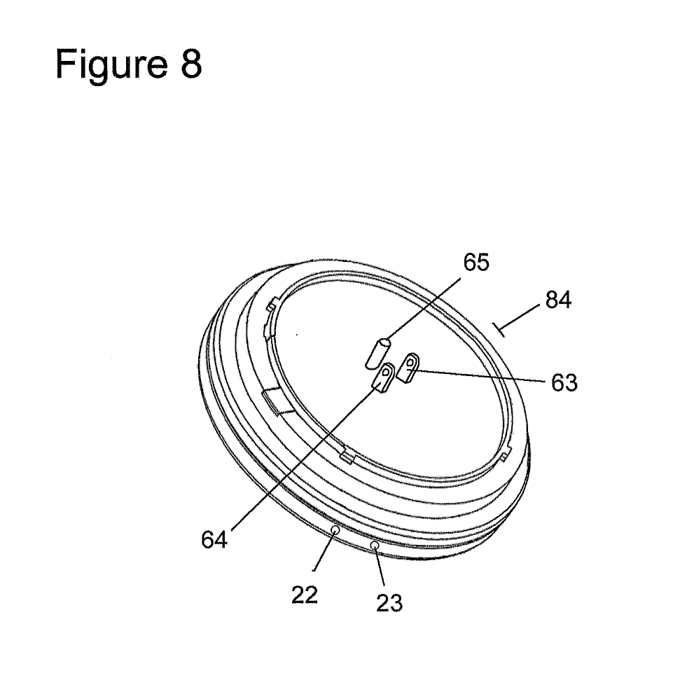

When a 9 VDC alert input comes from detection of the smoke or CO alarm through wire 6; or when a manual input occurs through pressing:
the test button on the alarm 5, or
an optional test button 22 (FIGS. 2, 6, 7, 8) on transceiver 4,

then (FIG. 5) the signal is filtered through a noise eliminating micro computer 10.

If a test button 22 is provided, there should also be a reset button 23 (FIGS. 2, 6, 7, 8).

If, as in FIG. 5, the signal passes a screening test by the noise eliminating micro computer 10, then a 9 VDC alarm signal is sent through output drive 24, which actuates audible warning device 26.

Additionally drive enable 30 is stimulated to actuate frequency stable oscillator 32, which outputs a radio frequency wave, preferably in this embodiment 455 kHz, to output power amplifier 34, which amplifies that wave. We may find as the population of these alarms becomes dense, that it is helpful to provide an adjustable frequency or provide adjustably coded signals, to discriminate between interfering alarm signals. An adjustment control for adjustable frequency or adjustably coded signals is contemplated within the scope of this invention.

The radio frequency (RF) wave then passes through filter 36, through impedance matching transformer 38, and is injected through the powerline interface 20, into power lines 6B and 6W, for receipt by the other transceivers to actuate their alarms 26.

When another alarm such as 5A (FIG. 3) actuates its alarm, its transceiver 4 injects a similar radio frequency signal through its powerline interface 20, and through its powerlines 6B and 6W, into the electrical power circuit of the structure.

In FIG. 5, the power and RF enter circuit 4 through wires 6B and 6W (FIG. 5). The signal goes through power line interface 20.

The signal is filtered through collision protection 40, and if it passes that screening, to receiver interface 42.

A band limited amplifier 44 amplifies only a specific frequency used as the alarm frequency, preferably, in the presently preferred embodiment a frequency of about 455 kHz. Sharp band pass filter 46 further screens and narrows the frequency. This narrowed wave is then input into band limited amplifier 48 which amplifies it. The amplified wave is input to a discriminator comparator 50 which ascertains that the input signal is indeed 455 kHz, or whatever is the preferred frequency of this particular model.

The signal is passed from discriminator comparator 50 to noise eliminating microcomputer 10, and if it is determined not to be noise, a signal is sent to output drive 24 which actuates sound warning 26.

As part of the repeater feature the noise eliminating microcomputer 10 also passes the signal to drive enable 30, which actuates frequency stable oscillator 32 to output the 455 kHz signal, which is amplified by power amplifier 34. The amplified wave then passes through band filter 36 to further narrow it. The narrowed wave then passes through impedance matching transformer 38, and then to powerline interface 20, where the amplified signal is again injected into power lines 6B and 6W, for further transmission down the power line, to other alarms 4, which might otherwise be out of range of the unit which transmitted the original alarm signal to the unit 4 depicted in FIG. 5.

FIG. 6 shows an alternate embodiment of transceiver 4 comprising a two prong plug 60 at the end of power cord 61. Cord 61 comprises power wires 6B and 6W. A conventional two prong power plug 60 has a live prong 63 and a neutral prong 64. Plug 60 may be plugged into any standard 120 VAC electrical outlet. This makes it easy for the electrically inept to install transceivers 4, where they are not required by code to be permanently wired.

An optioal test button 22 may be provided for an additional diagnostic tool, although the test button on the fire or CO alarm 5 can also test this part of the circuit. The advantage of the test button on unit 4 is that it allows the interface 4 to be tested independently of the detector 5.

A reset button 23 is a good way to terminate such a test, although the unit can alternately be designed to use a second press of Test 22 to terminate such a test.

1. A fire alarm system, for a structure having: rooms, power lines comprising power conductors, and alarms responsive to fire, smoke or Carbon Monoxide; said fire alarm system comprising:
an interconnected transceiver that uses power line carrier technology to inject a radio signal onto two of the power conductors;
the transceiver comprises:
a transmitter circuit; and
a receiver circuit;
the transmitter circuit comprises a trigger circuit, for an output line of a local alarm;
a trigger circuit can monitor said output line for an alarm condition output signal;
said transmitter circuit echoes any radio signal similar to the radio signal, thus serving as a repeater to increase a range and a reliability of the similar radio signal;
said transmitter circuit responds:
to said alarm condition output signal, or
to said similar radio signal,
by injecting the radio signal onto the power conductor.

2. The fire alarm system according to claim 1, in which said trigger circuit includes a microprocessor, for determining a validity of an alarm status, before activating said local alarm.

3. The fire alarm system according to claim 2, further comprising a second transceiver, similar to the transceiver;
said second transceiver is in a separate housing, for location in a second room of the structure;
said radio signal would activate the second transceiver, if the second transceiver is attached to the power lines in said structure.

4. An interface for a fire alarm system, said fire alarm system comprising individual externally-powered alarms responsive to smoke, fire, or Carbon Monoxide, for a structure having power lines comprising power conductors for transmitting power, wherein each of said alarms is located at a different part of said structure, and each alarm signals an alarm condition via an alarm output, said interface comprising:
a housing;
conductors for receiving the power from the power lines;
power output conductors for transmitting the power to a local one of said alarms;
a connector for the alarm output of the local alarm;
a transceiver;
the transceiver comprises:
a trigger circuit, responsive to the alarm condition, transmitted from the alarm output into the connector, by triggering the transmitter circuit;
a transmitter circuit, which responds to the alarm condition by injecting a first radio signal onto a power conductor, using power line carrier technology; and
a receiver circuit, which responds to a second radio signal, similar to the first radio signal, by:
triggering the transmitter circuit; and
triggering the local alarm.

5. An interface according to claim 4 in which the housing comprises a mount for the alarm.

6. An interface according to claim 5 in which the housing comprises a receptacle mount, for mounting the housing on a receptacle containing the power conductors.

7. An interface according to claim 6 in which,
the transceiver circuit is a two-wire interconnected transceiver circuit (4J) that uses power line carrier technology to inject the first radio signal as an RF signal onto two power conductors,
the transceiver circuit (4J) comprises:
the transmitter circuit (7); and
the receiver circuit (9);
the transmitter circuit (7) comprises the trigger circuit, attachable to the alarm output of the local alarm,
said trigger circuit, can monitor said the alarm output for the alarm condition;
said trigger circuit includes a microprocessor, for determining a validity of an alarm status, before:
activating said local alarm; and
injecting said first radio signal onto the two power conductors;
said first radio signal would activate any remote similar interface, attached to power lines in said structure, by:
a remote receiver circuit responds to the first radio signal, by:
triggering a remote transmitter circuit; and
triggering a remote alarm;
whereby the remote transmitter circuit (7) echoes the first radio signal, thus serving as a repeater to increase a range and a reliability of the first radio signal.

8. The interface according to claim 7, in which the radio signal is a 455 KHz sine wave.

9. The kit comprising a plurality the fire alarm interface according to claim 7.

10. The fire alarm system comprising:
a plurality of the fire alarm interface according to claim 9,
in which two of the interfaces are not on a same power line phase,
said fire alarm system further comprising a bridge circuit (11), installed between the two power line phases.

11. The fire alarm system according to claim 1, in which:
the local alarm (5) is integrated in a same housing as the alarm; and
the trigger circuit is connected to the output of the local alarm.

12. The said fire alarm system according to claim 10, wherein:
a section of the structure already has a group of local alarms;
each local alarm of the group is interconnected via its output line to a third conductor; and
only one interface is connected to the group of local alarms by said third conductor.

13. A method of interconnecting alarms in a structure, without installing a third conductor, said method comprising the steps of:
installing an interface comprising a transceiver between an alarm and said alarm's commercial power source, by:
disconnecting the alarm from two power conductors (6B & 6W) that supply the alarm's power;
connecting the interface (4) to the two power conductors;
connecting the interface to two power input conductors of the alarm; and
connecting the alarm's alarm output conductor to an alarm input of the interface (4);
similarly installing a second interface (4), and a second alarm, to said structure's commercial power source in another room of said structure.

14. The method of operating alarms, interconnected according to claim 13, comprising the further steps of:
said interface responding to an alarm condition from the alarm by injecting a radio signal onto the two power conductors;
said power conductors transmitting said radio signal to the second interface (4C);
said second interface receiving said radio signal;
said second interface reacting to said radio signal by transmitting an alarm signal to the second alarm's input conductor, thereby activating the second alarm.

15. The method of operating alarms, interconnected according to claim 14, in which, after:
“said second interface (4C) receiving said radio signal,”
there is an additional step of:
verifying a validity of said radio signal as an alarm signal, before transmitting an alarm signal to the second alarm's input conductor.

16. The method of operating alarms, interconnected according to claim 14, in which in the alarm's input conductor and the alarm's output conductor are the same conductor.

17. The method of interconnecting alarms according to claim 13, when there is a group of alarms that are already interconnected by an alarm conductor (16, 17, or 18), including the additional step of:
connecting the group by said group's alarm conductor to one interface (4A or 4B).

18. The method of interconnecting alarms according to claim 13,
when two interfaces (4A & 4B) are used in a structure, and
said two interfaces are not on a same phase, said method including the additional step of:
installing a bridge circuit (11) between the two phases.

19. The method of interconnecting alarms according to claim 13, when two interfaces (4A & 4B) are used in a structure, and the two interfaces are not on a same phase, including the additional step of:
changing one circuit (Circuit 1) supplying one of the interfaces (4B) onto the same phase (Circuit 2) as the other of the interfaces (4A).

20. A fire alarm system, in a structure not fully wired with a dedicated alarm conductor, said fire alarm system comprising:
an interface between an alarm and said alarm's commercial power source, said interface installed by:
disconnecting the alarm from two power conductors that supply the alarm's power;
connecting the interface to the two power conductors;
connecting the alarm to two power output conductors of the said interface; and
connecting the alarm's alarm conductor to an alarm wire (6CY) of the interface;
a second interface, similarly installed between a second alarm and said second alarm's commercial power source;
a circuit (4);
a pair of wires (6B) and (6W), through which:
power, and
the radio signal, as an RF alarm signal,
enter the circuit (4);
a power line interface (20) through which the RF alarm signal goes;
a collision protection (40v) through which the RF alarm signal is filtered, and
a receiver interface (42), to which, if said RF alarm signal passes the collision protection, said RF alarm signal is transmitted;
a band limited amplifier (44), which amplifies only a specific frequency used as an alarm frequency of the RF alarm signal;
a sharp band pass filter (46), to further screen and narrow the frequency;
a band limited amplifier (48) which amplifies said RF alarm signal,
a discriminator comparator (50), for input of the amplified said RF alarm signal, to ascertain that the input RF alarm signal is the specific frequency used as the alarm frequency;
a noise eliminating microcomputer (10), for:
processing the RF alarm signal from discriminator comparator (50),
ignoring noise,
sending the RF alarm signal to output drive (24),
passing the RF alarm signal to drive enable (30);
a drive enable (30), which actuates frequency stable oscillator (32) to output the RF alarm signal;
an output drive (24), for actuating sound warning (26);
a power amplifier (34) for amplifying the RF alarm signal;
a band filter (36) to further narrow RF alarm signal;
an impedance matching transformer (38);
a power-line interface (20), where the RF alarm signal is again injected into power lines (6B and 6W).

21. A fire alarm system, according to claim 20, further comprising:
a third alarm interface, which might otherwise be out of range of a remote alarm interface which transmitted an original RF alarm signal to the circuit.
